(19) United States
(12) Patent Application Publication
(10) Pub. No.: US 2006/0258801 A1
(43) Pub. Date: Nov. 16, 2006

(54) Aqueous polymer compositions

(76) Inventors: Emilio Martin, Waalwijk (NL); Gerardus Cornelis Overbeek, Waalwijk (NL); Marc Roelands, Waalwijk (NL); Rajasingham Satgurunathan, Waalwijk (NL)

Correspondence Address: NIXON & VANDERHYE, PC, 901 NORTH GLEBE ROAD, 11TH FLOOR, ARLINGTON, VA, 22203, US

(21) Appl. No.: 10/570,163

(22) PCT Filed: Jul. 26, 2004
(86) PCT No.: PCT/GB04/03229

§ 371 Date: Apr. 10, 2006

(30) Foreign Application Priority Data
Sep. 9, 2003 (GB) 0320994.7

(51) Int. Cl. C08G 18/08; C08K 3/20

(52) U.S. Cl. 524/591

(57) ABSTRACT

An aqueous coating composition comprising: (i) (10) to (80) wt % of a polyurethane A which exhibits a minimum film forming temperature of ≦ambient temperature and which comprises a polyurethane obtained by the reaction of: (a) an isocyanate-terminated pre-polymer formed from components which comprise: (1) 10 to 30 wt % of a polyisocyanate; (2) 0.1 to 10 wt % of a polyol of weight average molecular weight less than 500, containing ionic or potentially ionic water-dispersing groups, and having two or more isocyanate-reactive groups; (3) 0 to 15 wt % of a polyol containing non-ionic water dispersing groups having two or more isocyanate-reactive groups; (4) 40 to 80 wt % of a polyol other than (2) or (3), having two or more isocyanate-reactive groups; where (1), (2), (3) and (4) add up to 100%; and (b) an active-hydrogen chain extending compound; and (ii) 20 to 90 wt % of a polymer dispersion B which exhibits a minimum film forming temperature of above ambient temperature; wherein (i) and (ii) add up to 100%. Processes for manufacture of said composition and methods of application to substrates are also described.

The present invention relates to aqueous coating compositions comprising at least two different polymers with certain film-forming properties, processes for manufacturing such compositions and coatings derived therefrom.

It is known in the art to employ aqueous polymer dispersions of vinyl polymers or, alternatively, of polyurethanes as the basis of aqueous compositions for the production of coatings, the vinyl polymer or polyurethane providing the binder material for such coatings.

It is further known to employ vinyl polymers and polyurethanes in combination in aqueous polymer dispersions in order to further upgrade the properties of the resulting coating whereby the presence of each type of polymer (vinyl or urethane) will improve certain properties of the coating in comparison to using the other type of polymer on its own.

EP0350157 discloses mixtures of a polyurethane resin and an aqueous acrylic dispersion whose constituent monomers contain a carbonyl group-containing monomer or an amido-group containing monomer, but requires the two components to be functionally bonded in order to achieve the required combination of beneficial properties. Low temperature film-forming properties are not taught, neither is a balance of hardness and elasticity properties.

EP0842226 discloses blends of colloidal polymer dispersions of differing glass transition temperature which result in coherent film-forming dispersions which do not require the use of a volatile organic component (VOC) as a cosolvent or plasticiser. No use of polyurethane dispersions as either component in such mixtures is disclosed.

U.S. Pat. No. 5,817,735 describes a primer composition comprising a polyurethane and a polyacrylate wherein the urethane component has a glass transition temperature (Tg) in the range 20 to 50° C. and the acrylate component has a Tg in the range 10 to 90° C. No requirement is disclosed for the film forming properties of either component, and no benefits concerning elasticity are reported.

U.S. Pat. No. 5,281,655 discloses mixtures of urethane resins, resins such as polyacrylates, and a crosslinker for use in coatings, but does not stipulate the properties of either polymer component with regard to film-forming, nor does it disclose beneficial properties such as elasticity.

U.S. Pat. No. 6,384,131 discloses compositions containing polyurethane dispersions and water reducible resins such as polyacrylates for use in low VOC basecoat clearcoat coatings. No film forming properties of either component are disclosed, the key aim of the invention being to achieve low VOC levels.

U.S. Pat. No. 6,437,036 and U.S. Pat. No. 6,342,558 describe thermosetting aqueous primers which comprise a polyurethane polymer, an acrylic polymer and a cross-linking component. The Tg of the polyurethane should be below 0° C. and that of the polyacrylate at least 20° C. higher than the Tg of the polyurethane, with a preference of Tg for the polyacrylate of between −20° C. and 40° C. The compositions provide good resistance to stone chipping and can be formulated with very low VOC. No elasticity properties are inherent.

GB2362387 discloses mixtures of a multiphase polyacrylate, comprised of a ‘hard’ acrylate (Tg>20° C.), a ‘soft’ acrylate (Tg<20° C.), and a polyurethane, which may or may not be film forming at ambient temperature. Good hardness properties are achieved, but no elasticity results are inherent.

Surprisingly, we have now discovered that a certain combination of a polyurethane and a vinyl polymer in aqueous composition results in exceptionally good properties, and in particular a very advantageous balance of minimum film forming temperature (MFFT) and properties such as hardness and elasticity, which would normally work against each other or would require the incorporation of a coalescent solvent to achieve low MFFT, which is undesirable for environmental and flammability reasons. The invention composition overcomes such drawbacks.

According to the present invention there is provided an aqueous coating composition comprising:

(i) 10 to 80 wt % of a polyurethane A which exhibits a minimum film forming temperature of ≦ambient temperature and which comprises a polyurethane obtained by the reaction of:

(a) an isocyanate-terminated pre-polymer formed from components which comprise:
(1) 10 to 30 wt % of a polyisocyanate;
(2) 0.1 to 10 wt % of a polyol of weight average molecular weight less than 500, containing ionic or potentially ionic water-dispersing groups, and having two or more isocyanate-reactive groups;
(3) 0 to 15 wt % of a polyol containing non-ionic water dispersing groups having two or more isocyanate-reactive groups;
(4) 40 to 80 wt % of a polyol other than (2) or (3), having two or more isocyanate-reactive groups;

where (1), (2), (3) and (4) add up to 100%;

(b) an active-hydrogen chain extending compound; and

(ii) 20 to 90 wt % of a polymer B which exhibits a minimum film forming temperature of above ambient temperature;

wherein (i) and (ii) add up to 100%.

There is also provided a composition according to the above which further comprises 0 to 80 wt %, based on total polymer weight of A+B+C, of a vinyl polymer C which exhibits a minimum film forming temperature of ≦ambient temperature.

There is also provided a composition according to the above which comprises less than 5 wt % olefinically unsaturated double bonds based on total polymer weight. Such olefinically unsaturated double bonds typically arise from incorporation of components such as fatty acids into polyurethanes or monomers such as allylic vinyl monomers into vinyl polymers.

For the purposes of the invention an “aqueous dispersion” of a polymer, or an “aqueous composition” comprising it, means a dispersion or composition of the polymer in a liquid carrier medium of which water is the principle or only component. Such a dispersion will typically comprise colloidally dispersed polymer particles, i.e. will typically be in the form of an aqueous polymer latex.

It is evident from all the foregoing that the term “polyurethane” as used in this specification can mean one or more than one polyurethane, and is intended to apply not only to polymers (or prepolymers) having only urethane linkages formed from isocyanate and hydroxyl groups, but also to polymers, prepolymers or polymer segments having, in addition to urethane linkages, linkages formed from isocyanate groups and groups such as primary or secondary amines or thiols.

Ambient temperature for the purposes of film formation is to be taken herein as 10 to 25° C. By film forming it is meant that for example the polyurethane A if applied on its own as an aqueous dispersion forms a smooth, coherent and crack-free film at ≦ambient temperature.

There is further provided a composition according to the above wherein polyurethane A has a weight average molecular weight of at least 40000 Daltons, preferably 60000 Daltons, more preferably 80000 Daltons, as measured by Gel Permeation Chromatography (GPC), using THF as solvent and polystyrene as standard.

Polyurethane A may also comprise olefinic functionality, for example through the incorporation of HEMA (2-hydroxyethylmethacrylate) into the polyurethane.

The organic polyisocyanate (1) used for making the prepolymer of the polyurethane A is preferably an aliphatic (which term includes cycloaliphatic), araliphatic or aromatic polyisocyanate, or a mixture of aliphatic and aromatic polyisocyanates, and is preferably a diisocyanate.

Examples of suitable aliphatic polyisocyanates include ethylene diisocyanate, 1,6-hexamethylene diisocyanate, isophorone diisocyanate, cyclohexane-1,4-diisocyanate, 4,4′-dicyclohexylmethane diisocyanate, cyclopentylene diisoyanate, p-tetra-methylxylene diisocyanate (p-TMXDI) and its meta isomer (m-TMXDI), hydrogenated 2,4-toluene diisocyanate, hydrogenated 2,6-toluene diisocyanate, and 1-isocyanato-1-methyl-3(4)-isocyanatomethyl-cyclohexane (IMCI).

Suitable aromatic polyisocyanates include p-xylylene diisocyanate, 1-4-phenylene diisocyanate, 2,4-toluene diisocyanate, 2,6-toluene diisocyanate, 4,4′-diphenylmethane diisocyanate, 2,4-diphenylmethane diisocyanate, and 1,5-naphthylene diisocyanate.

Mixtures of polyisocyanates can be used and also polyisocyanates which have been modified by the introduction or urethane, allophanate, urea, biuret, carbodiimide, uretonimine or isocyanurate residues.

Preferred polyisocyanates are 4,4′-dicyclohexylmethane diisocyanate, isophorone diisocyanate and toluene-2,4-diisocyanate.

It will be appreciated that the isocyanate-reactive component (a)(2) to (a)(4) may optionally include an isocyanate-reactive compound which is other than a polyol (e.g. a diamine or an aminoalcohol); however, the polyol component will normally be entirely or substantially comprised of polyol reactant.

Polyurethane A preferably has internal dispersing groups built into its structure (preferably in pendant and/or terminal positions) during its synthesis (usually as part of the prepolymer) whereby such groups preferably render the polyurethane self-water-dispersible. Thus, although the polyurethane A may in principle be dispersible in water to form a stabilised dispersion therein solely as a result of the use of an external surfactant (if the polyurethane A has no internal dispersing groups), it is far more preferably dispersible as a result of the presence of internal dispersing groups—optionally, or if necessary, in conjunction with an external surfactant. Such are more usually chain pendant groups and may be of the ionic type (preferably anionic) or of the nonionic type, or a combination of ionic and nonionic types. For example, where the dispersing groups are of the anionic type, such as carboxyl groups, which need to be in their neutralised form (such as carboxylate anionic groups) to effect their internal dispersing action, the required amount of dispersing groups could be achieved by neutralising only a certain proportion of the potential anionic groups (e.g. carboxyl groups) or alternatively, fully neutralising all such groups but having a lower amount of them in the polymer.

Such internal dispersing groups may form part of the isocyanate-reactive components (a)(2) to (a)(4) and/or the polyisocyanate (a)(1), and/or may form part of the active hydrogen chain-extending compound (b). Most preferably such a reactant is part of the isocyanate-reactive component (a)(2) to (a)(4) and/or the polyisocyanate (a)(1) since this results in a self-water-dispersible polyurethane prepolymer component (and hence a final polyurethane polymer which is self-water-dispersible).

Anionic dispersing groups comprised by the polyol (a)(2) and optionally (a)(4) are for example —SO₃⁻, —OSO₃⁻, —PO₃⁻, and in particular a carboxylate salt group —CO₂⁻.

Groups which are subsequently converted to dispersing groups are non-ionised acid groups which can be converted to corresponding anionic groups by neutralisation. For example non-ionised carboxylic acid groups can be neutralised by addition of base to carboxylate anionic groups.

It is most preferred that dispersing groups are incorporated into the prepolymer (and/or less preferably by being part of the chain-extender component) via unionised carboxylic-acid groups which are subsequently neutralised to carboxylate ion groups using agents such as a tertiary amine, examples of which include triethylamine, triethanolamine, dimethylethanolamine or N-methylmorpholine, or an alkaline hydroxide such as K, Na or Li hydroxide or a quaternary ammonium hydroxide. Ammonia itself may also be used. Examples of reactants for effecting such incorporation include carboxyl group-bearing diols and triols, and in particular dihydroxy alkanoic acids. The most preferred carboxyl-bearing polyol is 2,2-dimethylol propionic acid (DMPA). Another preferred one is 2,2-dimethylol-n-butyric acid (DMBA). A mixture of DMPA and DMBA may also be used.

The conversion of any acid groups present in the prepolymer to anionic salt groups may be effected by neutralising the acid groups before, after or simultaneously with the formation of an aqueous dispersion of the prepolymer. Where acid groups are present additionally or only in the final polyurethane A by virtue of being incorporated additionally or only during the chain extension step the conversion of such groups to anionic salt groups may be effected by neutralising these acid groups during or after the formation of the final polyurethane A dispersion.

Generally speaking, it is preferred to use within the range of from 15 to 63 (more preferably 24 to 56, and most preferably 31 to 56) milli-equivalents of ionic (preferably anionic) internal dispersing groups per 100 g of urethane prepolymer solids (assuming such groups are being employed). In the case of using anionic dispersing groups this may be achieved by incorporating an amount of potential anionic groups into the polyurethane which on full neutralisation will provide the above preferred amount of ionic groups. Alternatively, an amount of potential anionic groups may be incorporated which on full neutralisation would provide a level greater than that preferred range mentioned above and only neutralising sufficient of these groups to provide the above preferred range of ionic dispersing groups (partial neutralisation).

Nonionic dispersing groups comprised by polyol (a)(3) are typically pendant polyoxyalkylene groups, particularly polyethylene oxide (PEO) groups. Such groups may, for example be provided by employing diols having pendant PEO chains as a reactant either in the prepolymer formation and/or (less preferably) as part of the chain-extender component. In U.S. Pat. No. 3,905,929 examples of such diol compounds are disclosed which may be obtained by reacting one mole of an organic diisocyanate in which the two isocyanate groups have different reactivities with approximately one mole of a polyethylene glycol mono-ether and then reacting the adduct so obtained with approximately one mole of a dialkanolamine, for example diethanolamine. Chain-pendant PEO groups may also be introduced by employing certain amine and hydroxyl functional compounds, or diols, as disclosed in EP 0317258, where such compounds are obtained by oxyalkylating a defined polyether amine containing PEO residues.

If desired, the PEO chains may contain units of other alkylene oxides in addition to the ethylene oxide units. Thus, PEO chains in which up to 60% of the alkylene oxide units are propylene oxide units, the remainder being ethylene oxide units, may be used.

In the case of nonionic internal dispersing groups (such as PEO chains) it is preferred to use a composition as described above wherein polyurethane A has a polyethylene oxide content of less than 15% by weight, preferably less than 5% by weight, more preferably zero % by weight of ethylene oxide groups based on total polymer weight.

The polymeric polyol of the isocyanate-reactive component (a)(4) is preferably a polymeric diol, but may be or include a polymeric polyol of functionality more than 2. The polymeric polyol preferably has a weight average molecular weight (hereinafter Mw) within the range of from 500 to 8,000 Daltons, more preferably from 700 to 3,000 Daltons. Such polyol is preferably essentially linear. Such polyol in principle may be selected from any of the chemical classes of polymeric polyols used or proposed to be used in polyurethane synthesis other than those described for components (a)(2) and (a)(3). In particular the polymeric polyol may be a polyester polyol, a polyesteramide polyol, a polyether polyol, a polythioether polyol, a polycarbonate polyol, a polyacetal polyol, a polyvinyl polyol and/or a polysiloxane polyol. More preferably the polymeric polyol is selected from a polyester polyol, a polyether polyol and/or a polysiloxane polyol, and particularly preferably is selected from a polyether polyol and/or a polyester polyol.

Polyester polyols which may be used include hydroxyl-terminated reaction products of polyhydric alcohols such as ethylene glycol, propylene glycol, diethylene glycol, neopentyl glycol, 1,4-butanediol, 1,6-hexanediol, furan dimethanol, cyclohexane dimethanol, glycerol, trimethylolpropane or pentaerythritol, or mixtures thereof, with polycarboxylic acids, especially dicarboxylic acids or their ester-forming derivatives, for example succinic, glutaric and adipic acids or their methyl esters, phthalic anhydrides or dimethyl terephthalate. Polyesters obtained by the polymerisation of lactones, for example caprolactone, in conjunction with a polyol may also be used. Polyesteramides may be obtained by the inclusion of amino-alchols such as ethanolamine in polyesterification mixtures. Polyesters which incorporate carboxy groups may be used, for example polyesters synthesised by esterification of DMPA and/or DMBA with diols, provided that the esterification is carried out at temperatures below 200° C. to retain the carboxy functionality in the final polyester.

Polyether polyols which may be used include products obtained by the polymerisation of a cyclic oxide, for example ethylene oxide, propylene oxide or tetrahydrofuran or by the addition of one or more such oxides to polyfunctional initiators, for example water, methylene glycol, ethylene glycol, propylene glycol, diethylene glycol, cyclohexane dimethanol, glycerol, trimethylopropane, pentaerythritol or Bisphenol A. Especially useful polyether polyols include polyoxypropylene diols and triols, poly (oxyethylene-oxypropylene) diols and triols obtained by the simultaneous or sequential addition of ethylene and propylene oxides to appropriate initiators and polytetramethylene ether glycols obtained by the polymerisation of tetrahydrofuran.

The isocyanate-reactive component may also include one or more organic monools.

The active hydrogen-containing chain-extending compound which may be reacted with the prepolymer component is preferably an amino-alcohol, a primary or secondary aliphatic, alicyclic, aromatic, araliphatic or heterocyclic diamine or polyamine (i.e. having 3 or more amine groups), or hydrazine or a substituted hydrazine, or a polyhydrazide (preferably a dihydrazide).

Water-soluble chain extenders are preferred.

Water itself may be used as an indirect chain-extender because it will slowly convert some of the terminal isocyanate groups of the prepolymer to amino groups (via unstable carbamic acid groups) and the modified prepolymer molecules will then undergo chain extension. However, this is very slow compared to chain extension using the above mentioned active hydrogen chain-extenders (which can be called added chain-extender compounds) which will provide the predominant chain extension reaction if used.

Examples of such added chain-extenders useful herein include ethylene diamine, diethylene triamine, triethylene tetramine, propylene diamine, butylene diamine, hexamethylene diamine, cyclohexylene diamine, piperazine, 2-methyl piperazine, phenylene diamine, toluylene diamine, xylylene diamine, tri(2-aminoethyl) amine, 3,3-dinitrobenzidine, 4,4′-diaminodiphenylmethane, methane diamine, m-xylene diamine, isophorone diamine, and adducts of diethylene triamine with acrylate or its hydrolysed products. Also materials such as hydrazine (e.g. in the form of its mono hydrate), azines such as acetone azine, substituted hydrazines such as, for example, dimethyl hydrazine, 1,6-hexamethylene-bis-hydrazine, carbodihydrazine, dihydrazides of dicarboxylic acids and sulphonic acids such as adipic acid dihydrazide, oxalic acid dihydrazide, isophthalic acid dihydrazide, hydrazides made by reacting lactones with hydrazine such as gamma-hydroxylbutyric hydrazide, bis-semi-carbazide, and bis-hydrazide carbonic esters of glycols. Another suitable class of chain-extenders is the so-called “Jeffamine” compounds with a functionality of 2 or 3 (available from Huntsman). These are polypropylene oxide (PPO) or PEO-based di or triamines, e.g. “Jeffamine” T403 and “Jeffamine” D-400.

Preferably the active hydrogen chain-extender component is or includes hydrazine (usually in the form of its monohydrate), or a di or triamine (usually a diamine) of molecular weight below 300.

When the chain-extender is an added component (not water), for example a polyamine or diamine or hydrazine, it may for example be added to the aqueous dispersion of prepolymer, or it may for example already be present in the aqueous medium when the prepolymer is dispersed therein, or it may for example simply be fed with the prepolymer to water.

The isocyanate-terminated prepolymer may be prepared in conventional manner by reacting a stoichiometric excess of the organic polyisocyanate with the isocyanate-reactive component (and any other reactants) under substantially anhydrous conditions at a temperature between about 30° C. and about 130° C. until reaction between the isocyanate groups and the isocyanate-reactive (usually all hydroxyl) groups is substantially complete. During the production of the isocyanate-terminated prepolymer the reactants are generally used in proportions corresponding to a ratio of isocyanate groups to isocyanate-reactive (usually all hydroxyl) groups from about 1.2:1 to 2.2:1, preferably from 1.3:1 to 2:1, more preferably from 1.4:1 to 1.7:1.

If desired, catalysts such as dibutyltin dilaurate or stannous octoate may be used to assist prepolymer formation. A diluent, such as an organic solvent or a reactive component, may optionally be added before, during or after prepolymer formation to control the viscosity provided it does not vitiate the obtaining of a solvent-free final dispersion (such solvent may thus subsequently need to be removed as far as is possible). Suitable solvents which may be used include acetone, methylethylketone, dimethylformamide, diglyme, N-methylpyrrolidone, ethyl acetate, ethylene and propylene glycol diacetates, alkyl ethers of ethylene and propylene glycol diacetates, alkyl ethers of ethylene and propylene glycol monoacetates, toluene, xylene and sterically hindered alcohols such as t-butanol and diacetone alcohol. The preferred solvents are water-miscible solvents such as N-methylpyrrolidone, acetone and dialkyl ethers of glycol acetates or mixtures of N-methylpyrrolidone and methyl ethyl ketone. In cases where the polymer B and/or C are formed in situ with the polyurethane A, the solvent for use in the prepolymer (if having suitable solvent characteristics) may be or may comprise (e.g. optionally in conjunction with organic solvents of the type described above) a monomer which is subsequently polymerised as the or as part of the monomer system to form the polymer B and/or C.

The polyurethane A is prepared as an aqueous dispersion by forming an aqueous dispersion of the isocyanate-terminated polyurethane prepolymer and dispersing it (optionally carried in an organic solvent medium which may include or consist of a monomer for other polymer such as polymer B and/or vinyl polymer C) in an aqueous medium, preferably utilising self-dispersibility properties of the prepolymer arising from internal dispersing groups in the isocyanate-terminated prepolymer, although free surfactant may additionally be employed if desired, and chain-extending the prepolymer with an active hydrogen compound in the aqueous phase, the chain-extender being present in the aqueous phase during dispersion or added subsequently (i.e. chain-extension can take place during and/or after the dispersion into water in this embodiment).

In an alternative embodiment, the prepolymer for polyurethane A may be dispersed in an aqueous medium in which polymer B and/or vinyl polymer C are already present, followed by chain extension as described above. In a further alternative embodiment, known as mass dispersion, the prepolymer may be dispersed in an aqueous medium in which are already dispersed the monomer components for polymer B and/or vinyl polymer C, followed by chain extension as described above. The monomer components for polymer B and/or vinyl polymer C are then polymerised as described below.

The prepolymer may be dispersed in water using techniques well known in the art. Preferably, the prepolymer is added to the water with agitation or, alternatively, water may be stirred into the prepolymer component.

The chain extension can be conducted at elevated, reduced or ambient temperatures. Convenient temperatures are from about 5° C. to 90° C., more preferably from 10 to 60° C.

The total amount of chain extender material employed (other than water) is preferably such that the ratio of active hydrogens in the chain extender to isocyanate (NCO) groups in the prepolymer component is preferably within the range of from 0.6:1 to 2.0:1 more preferably 0.8:1 to 1.2:1. Of course, when water is employed as an indirect chain extender, these ratios will not be applicable since the water, functioning both as an indirect chain extender and a dispersing medium, will be present in a gross excess relative to the residual NCO groups.

As is well known, the glass transition temperature of a polymer is the temperature at which it changes from a glassy brittle state to a plastic, rubbery state. The glass transition temperatures of the polymers in the examples were calculated by means of the Fox equation. Thus the Tg, in degrees Kelvin, of a copolymer having “n” copolymerised comonomers is given by the weight fractions W of each comonomer type and the Tg values of the homopolymers (in Kelvin) derived from each comonomer according to the equation:

$$\frac{1}{Tg} = \frac{{W}_{1}}{{Tg}_{1}} + \frac{{W}_{2}}{{Tg}_{2}} + ⋯ \frac{{W}_{n}}{{Tg}_{n}}$$

The calculated Tg in Kelvin may be readily converted to ° C.

In a preferred embodiment, the polymer B has a Tg of at least 30° C., preferably at least 40° C., more preferably at least 50° C., especially at least 60° C.

In another aspect of the invention, polymer B is multiphase, by which it is meant that it comprises at least one soft phase of Tg<20° C. and at least one hard phase of Tg>>20° C.

Polymer B preferably has a particle size distribution (hereinafter psd) of from 25 to 600 nm, and the psd may be monomodal or bimodal. In a preferred aspect of the invention, polymer B has a bimodal psd.

Preferred polymers comprised by polymer B are polymers for use in aqueous coating compositions, eg vinyl polymers such as acrylates; alkyd polymers, polyesters, epoxy polymers, fluorine-containing polymers, and/or hybrids of any of the preceding with polyurethanes. Preferred are vinyl polymers. Polymer B may also be an oligomer-supported polymer, by which is meant a low molecular weight oligomer (typically 5,000 to 50,000 Daltons) is first prepared as a stabilising agent for the second phase of the polymer preparation of polymer B.

By a vinyl polymer herein is meant a homo- or copolymer derived from the addition polymerisation (using a free radical initiated process and usually in an aqueous medium), preferably by aqueous emulsion polymerisation, of a monomer composition comprising one or more monomers of the formula:
CH₂═CR¹R²
where R¹ and R² are each independently selected from the group comprising H, optionally substituted alkyl of 1 to 20 carbon atoms (more preferably 1 to 8 carbon atoms), optionally substituted cycloalkyl of 5 to 20 carbon atoms, optionally substituted acyl and others. Such olefinically unsaturated monomers are referred to herein as vinyl monomers. Examples of such monomers include 1,3-butadiene, isoprene, styrene, α-methyl styrene, divinyl benzene, acrylonitrile, methacrylonitrile, vinyl halides such as vinyl chloride vinyl esters such as vinyl acetate, vinyl propionate, vinyl laurate, and vinyl esters of versatic acid such as VeoVa™ 9 and VeoVa™ 10 (VeoVa is a trademark of Shell), heterocyclic vinyl compounds, alkyl esters of mono-olefinically unsaturated dicarboxylic acids (such as di-n-butyl maleate and di-n-butyl fumarate, and olefinically unsaturated monocarboxylic or dicarboxylic acids, such as acrylic acid, methacrylic acid, 2-carboxyethyl acrylate, fumaric acid, maleic acid, and itaconic acid, and optionally substituted alkyl esters of 1 to 20 carbon atoms thereof.

In a preferred embodiment of the present invention, the polymer B comprises an acrylic polymer. By an acrylic polymer herein is meant a homo- or copolymer derived from the addition polymerisation of a monomer composition comprising at least 40 weight % of one or more monomers of the formula:
CH₂═CR³COOR⁴
where R³ is H or methyl, and R⁴ is H, optionally substituted alkyl of 1 to 20 carbon atoms (more preferably 1 to 8 carbon atoms) or cycloalkyl of 5 to 20 carbon atoms. Such monomers are referred to herein as acrylic monomers. More preferably, the monomer composition contains at least 50 weight % of acrylic monomer, and particularly at least 60 weight %. Examples of such acrylic monomers include methyl (meth)acrylate, ethyl (meth)acrylate, n-butyl (meth)acrylate, 2-ethylhexyl (meth)acrylate, isopropyl (meth)acrylate, n-propyl (meth)acrylate, and hydroxyalkyl (meth)acrylates such as hydroxyethyl (meth)acrylate and 2-hydroxypropyl (meth)acrylate. Preferred acrylic monomers include methyl methacrylate, n-butyl (meth)acrylate and 2-ethylhexyl acrylate.

When polymer B comprises an acrylic polymer, the monomer composition to form the acrylic polymer may include monomers, optionally vinyl, other than the acrylic monomers defined above and which are copolymerised with one or more of such acrylic monomers. Preferred vinyl monomers other than acrylate monomers are (meth)acrylic acid, styrene and acrylonitrile.

In a further embodiment, polymer B is present in the composition as a polymer hybrid (hereinafter a hybrid) by which is meant in this specification that the polymer B has been prepared in the presence of a polyurethane during and/or after the latter's formation. The hybrid may then be combined with further polymers, for example, the hybrid may be mixed with one or two separately prepared polymers, or with a sequentially formed pair of polymers (including oligomer supported polymers as described above).

Optional vinyl polymer C preferably has a MFFT of ≦ambient temperature, more preferably of below 10° C., further preferably below 5° C. Vinyl polymer C may also be multiphase as defined above for polymer B. Either or both of polymer B and vinyl polymer C may therefore be multiphase. Preferably vinyl polymer C comprises vinyl monomers as defined for polymer B above.

Vinyl polymer C may have a monomodal or bimodal psd.

Further preferably vinyl polymer C comprises an acrylate polymer as defined for polymer B above. Preferred acrylate monomers for vinyl polymer C are methyl methacrylate, n-butyl (meth)acrylate and 2-ethylhexyl acrylate. Other preferred monomers are (meth)acrylic acid, styrene and acrylonitrile. Vinyl polymer C may be an oligomer-supported polymer, as defined for polymer B above.

Polymer B and/or vinyl polymer C may often advantageously contain comonomers which provide an adhesion and/or crosslinking functionality to the resulting polymer coating. Examples of these, some of which have already been mentioned above, include acrylic and methacrylic monomers having at least one free carboxyl, hydroxyl, epoxy, aceto acetoxy, or amino group, such as acrylic acid and methacrylic acid (and also their amides, hydroxyalkyl esters and amino alkyl esters), glycidyl acrylate, glycidyl methacrylate, aceto acetoxy ethyl methacrylate, t-butylamino ethyl methacrylate and dimethylamino ethyl methacrylate; other adhesion promoting monomers include heterocyclic vinyl compounds such as vinyl pyrrolidone and vinyl imidazole. Polymer B and/or polymer C could also include monomers which impart in situ crosslinking (or “precrosslinking”) in the polymer, ie crosslinking in the polymer as it is being formed (rather than subsequently after a coating has been formed as do the crosslinking monomers mentioned above); examples of such monomers include allyl methacrylate, tetraethylene glycol methacrylate, and divinyl benzene.

Such monomers (described in the preceeding paragraph) when used are normally used in an amount of from 0.1 to 10 weight %, more usually from 0.1 to 5 weight % of the total weight of monomers used for polymerisation.

As discussed above, in one preferred embodiment of the invention, amino functionality can be incorporated into a multistage polymer by preparing a polymer comprising monomer units of an olefinically unsaturated acid, such as acrylic acid or methacrylic acid and subsequently converting at least a proportion of the carboxylic acid groups to amino groups (as part of amino ester groups) by an imination reaction using an alkylene imine such as ethylene imine or propylene imine.

If formed in situ polymer B and/or vinyl polymer C is made by an aqueous free-radical polymerisation process and such polymerisation may be performed simultaneously with the chain extension step of polyurethane A, or performed subsequent to the chain extension step, or performed partly simultaneously with the chain extension step and partly subsequent to the chain extension step.

All of the monomer to be polymerised in a hybrid may be present at the commencement of the polymerisation, or in cases where all or part of the monomer to be polymerised has been introduced subsequent to the formation of an aqueous prepolymer dispersion, some or all of that monomer may be added to the reaction medium during the course of the polymerisation (in one or more stages or continuously). Alternatively some or all of the monomer can be converted to polymer and be present In the aqueous phase before dispersion of the urethane prepolymer in the aqueous phase.

When making a hybrid, the monomer for making the in situ prepared polymer may be introduced in the process at any suitable stage. For example, when the aqueous dispersion of the urethane prepolymer is formed in the process to make the polyurethane polymer A all of the monomer for the polymer B and/or vinyl polymer C may be added to the prepolymer prior to its dispersion into water, or all of the monomer may be added subsequent to dispersion (or may have already been added to the water prior to the dispersion of the prepolymer therein), or part of the monomer may be added to the prepolymer prior to dispersion and the remainder added subsequent to dispersion. In the case where all or part of the monomer is added to the prepolymer prior to dispersion into water, such monomer could be added to the prepolymer subsequent to its formation or prior to its formation, or some could be added subsequent to its formation and some added prior to its formation. In the case where any monomer is added prior to the prepolymer formation it may (as mentioned above) provide at least part of a solvent system for the reaction to form the prepolymer (if it possesses suitable solvent characteristics). Particular examples of such processes are detailed in patents U.S. Pat. No. 5,137,961 and U.S. Pat. No. 4,664,430 which are herein incorporated by reference.

The polymerisation of the monomer composition to form polymer B and/or vinyl polymer C will normally require the use of a free-radical-yielding initiator to initiate the polymerisation. Suitable free-radical-yielding initiators include inorganic peroxides such as K, Na or ammonium persulphate, hydrogen peroxide, or percarbonates; organic peroxides, such as acyl peroxides including for example benzoyl peroxide, alkyl hydroperoxides such as t-butyl hydroperoxide and cumene hydroperoxide; dialkyl peroxides such as di-t-butyl peroxide; peroxy esters such as t-butyl perbenzoate and the like; mixtures may also be used. The peroxy compounds are in some cases advantageously used in combination with suitable reducing agents (redox systems) such as Na or K pyrosulphite or bisulphite, and i-ascorbic acid. Azo compounds such as azoisobutyronitrile may also be used. Metal compounds such as Fe.EDTA (EDTA is ethylene diamine tetracetic acid) may also be usefully employed as part of a redox initiator system. An initiator system partitioning between the aqueous and organic phases, for example a combination of t-butyl hydroperoxide, iso-ascorbic acid and Fe.EDTA, may be of particular use. The amount of initiator or initiator system to use is conventional, for example within the range 0.05 to 6 wt % based on the total monomer used.

An aqueous polymerisation to pre-form polymer B and/or vinyl polymer C normally needs to be performed in the presence of a stabilising and/or dispersing material, and when making an aqueous latex of a vinyl polymer, a conventional emulsifying agent would need to be employed (e.g. anionic and/or nonionic emulsifiers such as Na salts of dialkylsulphosuccinates, Na salts of sulphated oils, Na salts of alkyl sulphonic acids, Na, K and ammonium alkyl sulphates such as sodium lauryl sulphate, C2224 fatty alcohols, ethoxylated fatty acids and/or fatty amides, and Na salts of fatty acids such as Na stearate and Na oleate; the amount used is usually 0.1 to 5% by weight on the weight based on the total vinyl monomer used). When using an in situ process however to form polymer B and/or vinyl polymer C, a polyurethane polymer containing internal dispersing groups such as polyurethane A usually removes the requirement for the use of a separately added conventional emulsifying agent since the polyurethane itself acts as an effective dispersant for the polymerisation, although a conventional emulsifier can be still employed if desired.

A buffer material, such as sodium bicarbonate, is often employed in polymerisations to form vinyl polymers.

There is further provided a composition as described herein wherein any of polyurethane A, polymer B and vinyl polymer C are present at least as part of a hybrid.

In the invention dispersion, it is preferred that the weight average particle diameter (Dw) (i.e. the particle size—since the particles are essentially spherical) of the polyurethane A particles is within the range of from 20 to 400 nm, more preferably 30 to 150 nm. The Dw of the polymer B and/or C particles is preferably within the range of from 30 to 500 nm, more preferably from 45 to 250 nm and most preferably from 60 to 200 nm. (It is to be understood that Dw is also applicable to, i.e. is the average of, bimodal or polymodal particle size distributions, as well as monomodal distributions).

There is further provided a composition as described herein which further comprises up to 10 wt % of a cross-linker based on the total polymer weight (A+B and optionally C). The cross-linker is preferably selected from but not limited to the group comprising the following types: urea-formaldehyde, melamine-formaldehyde, carbodiimide, aziridine, epoxy, silanes and/or mixtures thereof. It is preferred that the crosslinking takes place at or around ambient temperature, and does not require excess application of heat eg stoving.

The invention composition, as discussed above, has an exceptionally advantageous combination of low MFFT and high hardness and elasticity properties. There is further provided a composition as described herein which exhibits a minimum film forming temperature of ≦ambient temperature as defined above. The MFFT of the invention composition is more preferably ≦20° C. and most preferably ≦15° C. Being aqueous based the lower limit of MFFT for the invention composition will be the freezing point of the aqueous carrier phase. This will usually be about 0° C. (perhaps slightly lower if there are any dissolved constituents, although not usually below −2° C.).

There is further provided according to the invention an aqueous coating composition as defined above which is substantially solvent-free. By a substantially solvent-free aqueous composition, is meant that the composition must contain less than 1.5 wt % of organic solvent based on total polymer solids, more preferably less than 0.5 wt %, and most preferably no solvent at all. It is particularly preferred that the aqueous composition contains less than 5 wt % of organic solvent based on polyurethane solids, more preferably less 2 wt %, and most preferably no solvent at all. (In this specification organic plasticisers are intended to be within the scope of the term “solvent”; these, like coalescent solvents, are also used in the art to decrease MFFT although strictly speaking they are not solvents). In a particularly preferred embodiment of the present invention, the composition as herein described is totally solvent (and therefore plasticiser) free.

In a particular embodiment, there is provided a composition as described herein which when coated gives a film of König hardness of at least 35 seconds, preferably in the range of from 35 to 120 seconds, more preferably more than 45 seconds, even more preferably between 50 and 70 seconds.

In a further particular embodiment, there is provided a composition as described herein which when coated gives a film of elongation in the range of from 80 to 400%, preferably 100 to 400%, more preferably 200 to 400%.

In an embodiment of the present invention there is provided a process for the manufacture of a composition as herein described which comprises the following steps:
(I) (i) reaction of components (a)(1) to (a)(4) to form an isocyanate-terminated prepolymer;
   (ii) dispersion of the isocyanate-terminated prepolymer in water;
   (iii) chain extension of the isocyanate-terminated prepolymer by reaction with an active-hydrogen chain extending compound to form polyurethane A; and
(II) admixture of preformed polymer B and/or vinyl polymer C.

In a further embodiment of the invention there is provided a process for the manufacture of a composition as herein described which comprises the following steps:
(I) (i) reaction of components (a)(1) to (a)(4) to form an isocyanate-terminated prepolymer;
   (ii) dispersion of the isocyanate-terminated prepolymer in water;
   (iii) chain extension of the isocyanate-terminated prepolymer by reaction with an active-hydrogen chain extending compound to form polyurethane A;
(II) admixture of monomer followed by reaction under conditions sufficient to effect polymerisation to form polymer B; and
(III) optional admixture of preformed vinyl polymer C.

In both the above process embodiments, it will be understood to those skilled in the art that steps (ii), (iii) and (II) may be performed in any order.

It is to be understood (as mentioned above) that a single polymer (with one Tg) may be produced in a hybrid, or 2 or more polymers may be formed with differing Tg values.

When the invention comprises a hybrid, it is preferred that the weight ratio of the polyurethane A to the other polymer(s) in the hybrid is within the range of from 5:95 to 99:1 more preferably from 15:85 to 90:10, and most preferably from 30:70 to 80:20.

Any or all of the above described processes for the manufacture of polymers A, B or C may be carried out by a technique which comprises in-line mixing, as described in Research Disclosure (2002), 457(May), P772-P774 or by the technique of mass dispersion, as described above.

The composition of the current invention may for example be used, appropriately formulated if necessary, for the provision of films, including inter alia polishes, varnishes, lacquers, or paints. The composition of the current invention may also be used for the provision of inks or adhesives. Optional further additives or components (to form compositions) include but are not limited to, defoamers, rheology control agents, thickeners, dispersing and stabilising agents (usually surfactants), wetting agents, fillers, extenders, fungicides, bacteriocides, anti-freeze agents, waxes and pigments.

In a particularly preferred embodiment, the composition as described herein further comprises a pigment and/or an extender. Pigments which may be used in the present invention include, for example, titanium dioxide, iron oxide, chromium-based compounds and metal phthalocyanine compounds. They are finely divided inorganic or organic powders (usually of particle size in the region of 0.1 to 10 μm, and obtained e.g. by grinding or milling) for achieving properties such as colour, opacity, and hiding power. They are usually incorporated into a coating composition in the form of a dry powder or a uniform dispersion of the pigment in a suitable carrier medium. Titanium dioxide (a white pigment) is the most preferred pigment in the present invention. Extenders which may be used include calcium carbonate and china clay.

There is further provided a composition as described herein with a pigment volume concentration (PVC) of from 10 to 35%, preferably 10 to 30%, more preferably 15 to 25%, wherein PVC is defined as:

$$\frac{[ volume ( pigment ) + volume ( extender ) ]}{[ \begin{matrix}volume ( pigment ) + volume ( extender ) + \\ volume ( binder )\end{matrix} ]}$$

wherein “binder” refers to the polymer composition according to the first embodiment of the present invention.

There is further provided according to the invention a method of coating the surfaces of a substrate using an aqueous composition as defined above. Preferably the substrate comprises architectural surfaces. Preferably such surfaces are porous, more preferably the surfaces are wood. In particular the compositions of the present invention are useful and suitable for providing the basis of protective coatings for wooden substrates (e.g. wooden floors and window frames), plastics and paper.

There is further provided according to the invention a coating obtained from a composition or a film or by a method as described above.

There is further provided according to the invention a substrate having a coating obtained as described above.

There is also provided a film obtained from a composition as described above.

The solids content of an aqueous composition of the invention is usually within the range of from about 20 to 65 wt % on a total weight basis, more usually 30 to 55 wt %. Solids content can, if desired, be adjusted by adding water or removing water (e.g. by distillation or ultrafiltration).

The compositions once applied may be allowed to dry naturally at ambient temperature, or the drying process may be accelerated by heat.

The present invention is now further illustrated but in no way limited by reference to the following examples. Unless otherwise specified all parts, percentages, and ratios are on a weight basis.

Determination of MFFT

The minimum film forming temperature (MFFT) of a composition as used herein is the temperature where the dispersion forms a smooth and crackfree coating or film using DIN 53787 and applied using a Sheen MFFT bar SS3000, determined under humidity conditions of relative humidity of 50±5%.

Determination Of film Formation on Card

100 micron wet films were cast on cardboard (Kraft liner) and left in a refrigerator at 4° C. for 24 hours, after which the coherency of the films were assessed visually, and a ranking between 0 and 5 was given. (5=crack free and coherent film; 0=powdery and non coherent film)

Determination of König Hardness

König hardness as used herein is a standard measure of hardness, being a determination of how the visco-elastic properties of a film formed from the composition slows down a swinging motion deforming the surface of the film, and is measured according to DIN 53157 using an Erichsen™ hardness equipment, wherein films were cast on glass plate at 80 micron wet film thickness at room temperature and allowed to stand for 30 minutes. The films were then transferred to an oven at 60° C. and left for 16 hours. The results are expressed as König seconds.

Determination of Elongation

A 400 micron wet film of the test composition is applied on glass panel containing release paper. This film is allowed to dry for 4 hours at ambient temperature and then 16 hours at 50° C. The film is then released from the release paper and cut into dumb bell shaped samples. Elongation of a sample is measured using an Instron™ instrument at a draw-bench speed of 100 mm/min. The result is expressed as a percentage, i.e. if the original length is x and the extended length is y, then the % elongation is 100[(y−x)/x].

### EXAMPLES

Polyurethanes A

Preparation of a polyurethane A1

A 2 l 3-necked round bottom flask, equipped with a stirrer and a thermometer, was loaded with dimethylolpropionic acid (DMPA) (70.00 g) and Voranol™ P2000 (Voranol is a registered trademark of Dow Chemicals Inc) (717.39 g) in a nitrogen atmosphere. The reaction mixture was stirred until the DMPA was homogeneously dispersed, and toluene diisocyanate (TDI) (212.00 g) was added. The reaction mixture was heated slowly to 60° C., tin octoate catalyst (0.20 g) was added and the reaction mixture was slowly heated until a reaction temperature of 90° C. was reached. This temperature was maintained for 3.5 hours. Every hour additional portions of tin octoate (0.20 g) were added. The resultant isocyanate terminated prepolymer was cooled to 70° C. The residual isocyanate content of the prepolymer was 2.80% (theoretical 2.94%).

The prepolymer (850 g), at 70° C., was dispersed in a reactor containing a solution of triethylamine (44.89 g), hydrazine monohydrate (13.85 g) and water (1693.67 g; 25° C.), over a period of 90 minutes. During this time, the temperature of the water phase was kept at 25° C. After the addition was complete, the final dispersion was stirred for an additional 15 minutes.

The resulting polyurethane dispersion A1 had a pH of 8.0, a viscosity of 450 mPa·s, a solids content of 33 wt % and a MFFT of <0° C.

Preparation of a Polyurethane A2

The method of polyurethane A1 was followed to make a prepolymer from methyl methacrylate (MMA) (220.00 g), butylated hydroxy toluene (0.229), dimethylolpropionic acid (DMPA) (44.00 g), Priplast™ 3192 (Priplast is a registered trademark of Uniqema Chemie b.v.) (623.10 g) and isophorone diisocyanate (IPDI) (212.90 g). The residual isocyanate content of the prepolymer was 2.28% (theoretical 2.38%). Subsequently, the prepolymer was neutralised with triethylamine (TEA) (33.20 g).

The neutralised prepolymer (927.17 g), at 70° C., was dispersed in a reactor (in a nitrogen atmosphere) containing water (1576.41 g; 30° C.), over a period of 60 minutes. During this time, the temperature of the water phase was kept at 30° C. After the addition was complete, hydrazine monohydrate (10.70 g) and water (49.30 g) were added. The final dispersion was stirred for an additional 30 minutes.

Subsequently, a 10% aqueous solution of tert-butyl hydroxy peroxide (tBHPO) (9.00 g) together with Iron ethylene diamine tetracetic acid complex (FeEDTA, 1% aqueous solution) (0.90 g) was added. Finally, a 2,5% aqueous solution (pH>8) of iso-ascorbic acid was fed over a period of 30 minutes to the reactor, leading to a temperature increase of approximately 10° C.

The resulting polyurethane dispersion A2 had a pH of 8.1, a viscosity of 70 mPa·s, a solids content of 35 wt % and a MFFT of <0° C.

Polymer B

Polymer B1 is NeoCryl™ A1131, a multi-phase vinyl polymer latex (solids content=40%, MFFT=86° C.) available from Avecia bv.
Polymer B2 is NeoCryl™ A633, a single-phase vinyl polymer latex (solids content=42.5%, MFFT=55° C.) available from Avecia bv.
Polymer B3 is NeoPac™ E125, a multi-phase, self X-linking urethane-acrylic polymer latex (solids content=35%, MFFT=50° C.) available from Avecia bv.
   Vinyl Polymer C
Vinyl Polymer C1 is NeoCryl™ XK98, a multi-phase, self X-linking vinyl polymer latex (solids content=44%, MFFT=<0° C.) available from Avecia bv.
Vinyl Polymer C2 is NeoCryl™ XK99, a multi-phase vinyl polymer latex (solids content=44%, MFFT=<0° C.) available from Avecia bv.

### Example 1

Preparation of a Blend of a Polyurethane A1 and a Polymer B1

A 500 ml 3-necked round bottom flask, equipped with a stirrer, was loaded with urethane dispersion A1 (200.00 g) in a nitrogen atmosphere, and then polymer B1 (110.00 g) was added while stirring the mixture. The obtained blend was stirred for an additional 20 minutes at room temperature. The blend had a solids content of 35.5 wt %, and a pH of 8.0.

### Example 2

Preparation of a Blend of a Polyurethane A1, polymer B1 and vinyl polymer C1

A 500 ml 3-necked round bottom flask, equipped with a stirrer, was loaded with urethane dispersion A1 (136.36 g) in a nitrogen atmosphere, and then polymer B1 (87.50 g) and vinyl polymer C1 (45.45 g) were added while stirring the mixture. The obtained blend was stirred for an additional 20 minutes at room temperature. The blend had a solids content of 37.1 wt %, and a pH of 8.0.

### Example 3

Preparation of a Blend of a Polyurethane A1, Polymer B1 and Vinyl Polymer C2

The method of Example 2 was followed using urethane dispersion A1 (136.36 g), polymer B1 (87.50 g) and vinyl polymer C2 (45.45 g). The blend had a solids content of 37.1 wt %, and a pH of 8.0.

### Example 4

Preparation of a Blend of a Polyurethane A2 and a Polymer B1

The method of Example 1 was followed using urethane dispersion A2 (200.00 g) and polymer B1 (75.009). The blend had a solids content of 36.4 wt %, and a pH of 8.2.

### Example 5

Preparation of a Blend of a Polyurethane A2 and a Polymer B2

The method of Example 1 was followed using urethane dispersion A2 (200.00 g) and polymer B2 (70.59 g). The blend had a solids content of 37.0 wt %, and a pH of 8.1.

### Example 6

Preparation of a Blend of a Polyurethane A2 and a Polymer B3

The method of Example 1 was followed using urethane dispersion A2 (200.00 g) and polymer B3 (85.719). The blend had a solids content of 35.0 wt %, and a pH of 8.0.

### Example 7

Preparation of a Polyurethane A—Polymer B Hybrid Latex, Based on Polyurethane A1

A 500 ml 3-necked round bottom flask, equipped with a stirrer, was loaded with water (77.24 g) and polyurethane dispersion A¹ (200.00 g) in a nitrogen atmosphere. While stirring, a vinyl monomer mixture of methyl methacrylate (MMA) (26.98 g) and butyl acrylate (BA) (5.53 g) was added and the reactor mixture was allowed to mix for 60 minutes at 25° C. Then a 10% aqueous solution of tert-butyl hydroxy peroxide (tBHPO) (2.02 g) together with iron ethylene diamine tetraacetic acid complex (FeEDTA, 1% aqueous solution) (0.29 g) was added, followed by a 1% aqueous solution of iso-ascorbic acid (5.66 g). The temperature of the reaction mixture increased approximately 15° C. Subsequently, an extra amount of vinyl monomer mixture of methyl methacrylate (MMA) (26.98 g) and butyl acrylate (BA) (5.53 g) was added and the reactor mixture was again allowed to mix for 60 minutes. Then a 1% aqueous solution of iso-ascorbic acid (5.66 g) was added to the reactor, leading to a temperature increase of approximately 13° C. Finally, a last portion of a 1% aqueous solution of iso-ascorbic acid (16.0 g) was added to the reactor.

The hybrid dispersion had a solids content of 35.0 wt %, and a pH of 8.55.

### Example 8

Preparation of a Polyurethane A—Polymer B Hybrid Latex, Based on Polyurethane A2

A 1000 ml 3-necked round bottom flask, equipped with a stirrer, was loaded with water (105.63 g) and polyurethane dispersion A2 (500.00 g) in a nitrogen atmosphere. While stirring, a vinyl monomer mixture of styrene (STY) (31.40 g) and butyl acrylate (BA) (6.11 g) was added and the reactor mixture was allowed to mix for 60 minutes at 25° C. Then a 10% aqueous solution of tert-butyl hydroxy peroxide (tBHPO) (2.33 g) together with iron ethylene diamine tetraacetic acid complex (FeEDTA, 1% aqueous solution) (0.33 g) was added, followed by a 1% aqueous solution of iso-ascorbic acid (6.53 g). The temperature of the reaction mixture increased approximately 6° C. Subsequently, an extra amount of vinyl monomer mixture of styrene (STY) (26.989) and butyl acrylate (BA) (6.11 g) was added and the reactor mixture was again allowed to mix for 60 minutes. Then a 1% aqueous solution of iso-ascorbic acid (6.53 g) was added to the reactor, leading to a temperature increase of approximately 6° C. Finally, a last portion of a 1% aqueous solution of iso-ascorbic acid (19.59 g) was added to the reactor.

The hybrid dispersion had a solids content of 35.0 wt %, and a pH of 8.20.

Preparation of Pigment Paste P1

A pigment paste was prepared mixing demineralised water (45 g), Drewplus™ S4386 (ex Äshland) (3 g), Disperbyk™ 190 (ex BykChemie) (6 g) and TiO₂ RHD2 (ex Huntsman Tioxide) (210 g) for 30 minutes. The resulting pigment paste had a grind fineness of 10 micron and a solids content of 80 wt %.

### Example 9

Preparation of a Pigmented Formulation of Example 1

The blend of polyurethane latex A1 and NeoCryl™ A1131 obtained from Example 1 was combined by stirring with 126.40 g of pigment paste P1. The obtained paint had pigment volume concentration (PVC) of 20%, solids content of 48.4 wt %, and a pH of 7.9.

### Example 10

Preparation of a Pigmented Formulation of Example 7

The hybrid latex of polyurethane latex A1 with MMA and BA obtained from Example 7 was combined by stirring with 126.40 g of pigment paste P1. The obtained paint had pigment volume concentration (PVC) of 20%, solids content of 48.4 wt %, and a pH of 7.9.

### Comparative Example 1

A 500 ml 3-necked round bottom flask, equipped with a stirrer, was loaded with polyurethane dispersion NeoRez™ R980 (isocyanate content=35 wt %, solids content=34%, MFFT<0° C., available from Avecia by) (176.47 g) in a nitrogen atmosphere, and then polymer B1 (100.00 g) was added while stirring the mixture. The obtained blend was stirred for an additional 20 minutes at room temperature. The blend had a solids content of 36.2 wt %, and a pH of 8.0.

### Comparative Example 2

Example 4 of GB 2 362 387 which comprised a sequential acrylic polymer AP4 was mixed with 30 wt % (on dispersion) of NeoRez™ R980 (isocyanate content=35 wt %, solids content=34%, MFFT<0° C., available from Avecia by).

The compositions of Examples 1 to 10 and Comparative Examples 1 and 2 are summarised in Table 1 below.

Films from the above blends Examples 1 to 10 and Comparative Examples 1 and 2 were cast and the properties are shown in Table 2 below.

TABLE 1

| | | | | | | MFFT | MFFT |
|---|---|---|---|---|---|---|---|
| | | % NCO | % DMPA | % polyol | | of B | of C |
| Example | A:B:C (wt %) | in A | in A | (4) in A | diluent in A | (° C.) | (° C.) |
| 1 | 60:40:0 | 21.28 | 7.00 | 71.64 | none | 86 | n.a. |
| 2 | 45:35:20 | 21.28 | 7.00 | 71.64 | none | 86 | <0 |
| 3 | 45:35:20 | 21.28 | 7.00 | 71.64 | none | 86 | <0 |
| 4 | 70:30:0 | 24.19 | 5.00 | 70.81 | 20% MMA | 86 | <0 |
| 5 | 70:30:0 | 24.19 | 5.00 | 70.81 | 20% MMA | 65 | <0 |
| 6 | 70:30:0 | 24.19 | 5.00 | 70.81 | 20% MMA | 50 | <0 |
| 7 | 50:50:0 | 21.28 | 7.00 | 71.64 | none | Tg = 65 | n.a. |
| 8 | 56:44:0 | 24.19 | 5.00 | 70.81 | 20% MMA | Tg = 65 | n.a. |
| 9 | 60:40:0 | 21.28 | 7.00 | 71.64 | none | 86 | n.a. |
| 10 | 50:50:0 | 21.28 | 7.00 | 71.64 | none | Tg = 65 | n.a. |
| C1 | 60:40:0 | 35 | 5.00 | 59.9 | none | 86 | n.a. |
| C2 | 70:30:0 | 35 | 5.00 | 59.9 | none | Tg = 38 | n.a. |

TABLE 2

| | König hardness | Elongation | Overall |
|---|---|---|---|
| Example | (s) | (%) | MFFT (° C.) |
| 1 | 50 | 370 | <5 |
| 2 | 50 | 293 | <5 |
| 3 | 54 | 261 | <5 |
| 4 | 68 | 193 | <5 |
| 5 | 59 | 225 | <5 |
| 6 | 57 | 175 | <5 |
| 7 | 40 | 354 | <5 |
| 8 | 64 | 220 | <5 |
| 9 | 64 | 105 | <5 |
| 10 | 69 | 150 | <5 |
| C1 | 84 | <10 | <5 |
| C2 | 90 | 21 | <5 |

1. An aqueous coating composition comprising:
(i) 10 to 80 wt % of a polyurethane A which exhibits a minimum film forming temperature of ≦ambient temperature and which comprises a polyurethane obtained by the reaction of:
(a) an isocyanate-terminated pre-polymer formed from components which comprise:
(1) 10 to 30 wt % of a polyisocyanate;
(2) 0.1 to 10 wt % of a polyol of weight average molecular weight less than 500, containing ionic or potentially ionic water-dispersing groups, and having two or more isocyanate-reactive groups;
(3) 0 to 15 wt % of a polyol containing non-ionic water dispersing groups having two or more isocyanate-reactive groups;
(4) 40 to 80 wt % of a polyol other than (2) or (3), having two or more isocyanate-reactive groups;
where (1), (2), (3) and (4) add up to 100%; and
(b) an active-hydrogen chain extending compound; and
(ii) 20 to 90 wt % of a polymer dispersion B which exhibits a minimum film forming temperature of above ambient temperature;
wherein (i) and (ii) add up to 100%.

2. A composition according to claim 1 which further comprises 0 to 80 wt %, based on total polymer weight of A+B+C, of a vinyl polymer C which exhibits a minimum film forming temperature of <ambient temperature.

3. A composition according to either claim 1 or claim 2 which comprises less than 5 wt % olefinically unsaturated double bonds based on total polymer weight.

4. A composition according to any one of the preceding claims which exhibits a minimum film forming temperature of ≦ambient temperature.

5. A composition according to any one of the preceding claims which when coated gives a film of König hardness of at least 35 seconds.

6. A composition according to any one of the preceding claims which when in the form of a film has elongation in the range of from 80 to 400%.

7. A composition according to any one of the preceding claims wherein polyurethane A has a polyethylene oxide content of less than 15% by weight of ethylene oxide groups based on total polymer weight.

8. A composition according to any one of the preceding claims wherein polyurethane A has a weight average molecular weight of at least 40000 Daltons.

9. A composition according to any one of the preceding claims wherein the active-hydrogen chain extending compound comprised in polyurethane A is selected from the group comprising amino-alcohols; primary or secondary aliphatic, alicyclic, aromatic, araliphatic or heterocyclic diamines or polyamines; hydrazine; substituted hydrazines; or, polyhydrazides.

10. A composition according to any of the preceding claims wherein any of polyurethane A, polymer B and vinyl polymer C are present at least as part of a hybrid.

11. A composition according to any one of the preceding claims wherein either or both of polymer B and vinyl polymer C comprise a multiphase polymer.

12. A composition according to any one of the preceding claims wherein polymer B has a Tg of at least 30° C.

13. A composition according to any one of the preceding claims which further comprises up to 10 wt % of a crosslinker based on the total polymer weight of A+B+C.

14. A composition according to any one of the preceding claims which further comprises a pigment.

15. A composition according to claim 14 with a pigment volume concentration of from 10 to 35%.

16. A composition according to any one of the preceding claims which is substantially solvent free.

17. A process for the manufacture of a composition according to any one of claims 1 to 16 which comprises the following steps:
(I) (i) reaction of components (a)(1) to (a)(4) together to form an isocyanate-terminated prepolymer;
(ii) dispersion of the isocyanate-terminated prepolymer in water;
(iii) chain extension of the isocyanate-terminated prepolymer by reaction with an active-hydrogen chain extending compound to form polyurethane A; and
(II) admixture of preformed polymer B and/or vinyl polymer C.

18. A process for the manufacture of a composition according to any one of claims 1 to 16 which comprises the following steps:
(I) (i) reaction of components (a)(1) to (a)(4) to form an isocyanate-terminated prepolymer;
(ii) dispersion of the isocyanate-terminated prepolymer in water;
(iii) chain extension of the isocyanate-terminated prepolymer by reaction with an active-hydrogen chain extending compound to form polyurethane A;
(II) admixture of monomer followed by reaction under conditions sufficient to effect emulsion polymerisation to form polymer B; and
(III) optional admixture of preformed vinyl polymer C.

19. A film obtained from a composition according to any one of claims 1 to 16.

20. A method of coating the surfaces of a substrate using an aqueous composition according to any one of claims 1 to 16.

21. A method according to claim 20 wherein the surfaces are porous.

22. A method according to claim 20 wherein the surfaces are wood.

23. A coating obtained from a composition according to any of claims 1 to 16.

24. A substrate having a coating according to claim 23.
